(19) United States
(12) Patent Application Publication
(10) Pub. No.: US 2008/0164377 A1
(43) Pub. Date: Jul. 10, 2008

(54) SECURED COCKPIT FOR AN AIRCRAFT

(75) Inventors: Vincent Lautridou, Colomiers (FR); Jean-Luc Orgerie, Toulouse (FR); Gilles Marquet, Toulouse (FR)

Correspondence Address: OBLON, SPIVAK, MCCLELLAND MAIER & NEUSTADT, P.C., 1940 DUKE STREET, ALEXANDRIA, VA, 22314, US

(73) Assignee: Airbus France, Toulouse (FR)

(21) Appl. No.: 11/965,142

(22) Filed: Dec. 27, 2007

(30) Foreign Application Priority Data
Jan. 10, 2007 (FR) 0752610

(51) Int. Cl. B64C 13/04; B64D 11/00

(52) U.S. Cl. 244/229; 244/118.5

(57) ABSTRACT

This cockpit (2) is a secured cockpit for an aircraft intended for transportation of passengers.

It has on the one hand a pilot station (14) equipped with aircraft flight control means and on the other hand a wall (8) separating the said cockpit (2) from a zone (10) accessible to the passengers.

This separating wall (8) is equipped with a secured door (12).

The cockpit (2) is additionally provided with a private lavatory (18) and a rest zone (16).

The present invention relates to a secured cockpit for an aircraft.

Since the events of 11 Sep. 2001, the security of pilots in an aircraft has been an important element in aircraft design, in order to be able to prevent any unauthorized person from entering the aircraft cockpit. Before these events, the cockpit generally was separated from the aircraft cabin only by one (or two) doors, which were not armor-plated.

Regulations adopted following these events provide for strict isolation of the pilot station from the rest of the aircraft. It is advisable to provide, between the cockpit and cabin of the aircraft, at least one door that is said to be “secured” and that must resist the intrusion attempts of an ill-intentioned person and must withstand light-arms projectiles.

In aircraft already in operation when the new regulations were adopted, the unsecured door that most often separated the cabin from the cockpit was replaced with an armor-plated door equipped with an opening system remote-controlled from the cockpit. In certain aircraft, the separating partition between the cockpit and the outside also sometimes was replaced by an armor-plated partition.

In certain aircraft, supplementary security equipment also was provided. Thus, for certain aircraft, rest compartments for the crew were furnished with armor-plated partitions and/or locking systems (with key or code). When the layout of the aircraft permits, a supplementary door sometimes also was provided between the passengers and the cockpit door. This additional door, not controlled from the cockpit, is most often locked by code or by key and serves to block the visibility of the cockpit door from the passengers.

For example, document U.S. Pat. No. 6,702,231 discloses a set of doors comprising a cockpit door and a lavatory door, in which the lavatory door is mounted in a double chassis in such a way that the lavatory door can also serve as a door for creating an airlock between the cockpit door and the cabin.

In practice, it is noted that secured doors must be opened numerous times in a civil transportation aircraft during a flight, especially a long-distance flight. Such openings are noted in particular when:
the pilots are going to rest or take turns,
beverages and/or meals are being brought to the pilots,
the pilots are visiting the lavatories (which in most cases are common with those of the cabin),
the pilots need a document stored outside the cockpit, etc.

These numerous openings of secured doors represent commensurate risks of undesired intrusion into the interior of a zone reserved for the flight personnel and also the cockpit.

Document U.S. Pat. No. 7,014,148 proposes integrating a lavatory in the cockpit door of an aircraft. While this solution makes it possible to limit the number of openings of the secured door separating the cockpit from the cabin of the aircraft, it has the disadvantage of limiting the comfort of the pilots. In effect, it proposes a lavatory of limited size, whose use requires several manipulations. In addition, this solution is applicable only to certain aircraft configurations, so that in particular the door integrating the lavatory can be opened. Thus the space gained by integrating a lavatory into the cockpit door involves a loss of space outside the cockpit, because it requires that a large clearance be provided behind this door so that it can be opened.

The objective of the present invention is then to provide a configuration that makes it possible to limit the risks of intrusion into the cockpit by an unauthorized person, while preserving the comfort of the pilots.

To this end, it proposes a secured cockpit for an aircraft intended for transportation of passengers, having on the one hand a pilot station equipped with aircraft flight control means and on the other hand a wall separating the said cockpit from a zone accessible to the passengers, the said wall being equipped with a secured door. According to the invention, this cockpit is additionally provided with a private lavatory and a rest zone.

By cockpit there is understood here the aircraft compartment that serves to house the technical crew of this aircraft during the different phases of the flight. In general, this term is synonymous with the pilot station. Here, however, there is understood by pilot station the cockpit zone reserved for flying the aircraft. The pilot station is therefore provided with seats to accommodate the pilots during the phases of the flight as well as aircraft control means, monitoring screens, etc.

The configuration proposed by the invention makes it possible to enlarge the cockpit compared with a prior art cockpit, traditionally reserved for flying the aircraft. The cockpit here becomes a personal space for the pilots, both for pilots flying the aircraft and for relief pilots provided to take over from the pilots at the controls.

To increase the autonomy of a cockpit according to the invention, this cockpit is advantageously provided in addition with a storage space, such as a locker and possibly also a pantry unit. The locker is preferably large enough to accommodate the working equipment and the personal gear of the pilots at the controls of the airplane and also of the relief pilot or pilots who are resting. The pantry unit here is composed of one or more elements by means of which cold and hot drinks as well as meals can be supplied to the pilots. The usual name given to such a pantry unit is the English term “galley”.

A preferred embodiment provides that the private lavatory and the rest zone are each equipped with a partition separating them from the rest of the pilot station as well as with their own access door. This preferred embodiment permits greater comfort for the pilots, both those at the controls of the aircraft and those who are resting. These access doors advantageously permit direct access from the pilot station to the private lavatory or to the rest zone without having to pass through another door.

To ensure that the occupants of the cockpit according to the invention can communicate effectively with the rest of the aircraft, the cockpit is provided with communication means, for example, with which, from a dedicated zone in the cabin, the flight personnel and/or the passengers can see and hear pilots occupying the pilot station.

In an alternative embodiment of a cockpit according to the invention, the private lavatory is placed against the separating wall.

To gain space, it can be provided, for example, that the rest zone is placed at a lower level than the pilot station and that it is accessible exclusively from the cockpit via a trapdoor, or else that the rest zone is placed at least partly above a zone accessible to the passengers. In this latter embodiment, the wall separating the rest zone from the zone accessible to the passengers is preferably armor-plated, so that any intrusion from the cabin into the rest zone and therefore into the cockpit can be prevented.

Finally, the present invention relates to an aircraft, characterized in that it is provided with a cockpit such as described hereinabove.

Details and advantages of the present invention will become more apparent from the description hereinafter, given with reference to the attached schematic drawings, wherein:

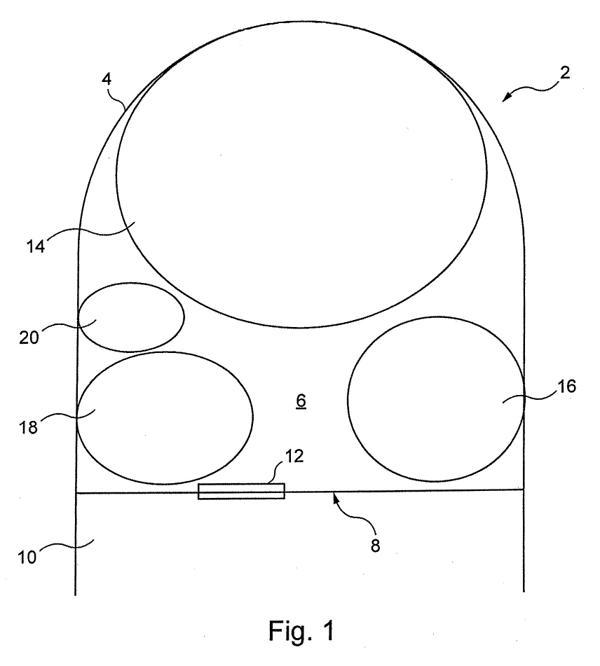

FIG. 1 is a schematic and intentionally vague diagram of a view from above of a cockpit according to the invention, and

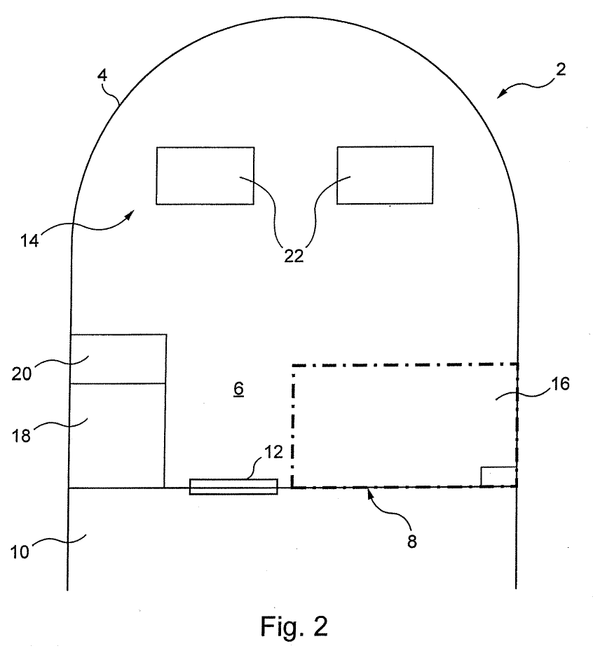

FIG. 2 is a view similar to the view of FIG. 1, showing an embodiment of a cockpit according to the invention in more detail.

A schematic diagram of an aircraft cockpit 2 is seen in FIG. 1. In the rest of the description there is understood by cockpit the aircraft compartment serving to house the technical crew of this aircraft during the different phases of the flight, this crew generally comprising two pilots—one pilot and one copilot—(which is the most common case for an aircraft intended for commercial transportation of passengers).

Cockpit 2 is in this case situated at the front of the aircraft under consideration, and there is recognized the usual rounded shape of the front of an aircraft in FIG. 1. This cockpit 2 is bounded on the one hand from the outside of the aircraft by an outer wall 4 of the aircraft forming the front fuselage and on the other hand by a floor 6 assumed to be substantially horizontal and a separating partition 8 assumed to be substantially vertical.

As is the case in the majority of aircraft, it is assumed here that the aircraft is of single-deck type and that floor 6 of cockpit 2 is the extension toward the front of the aircraft of a floor of a cabin 10 intended to accommodate the passengers.

Separating partition 8 makes it possible to separate cabin 10, which is also the zone to which the passengers have authorized access, from cockpit 2, which only the flight crew or even exclusively the pilots are authorized to enter during a flight. This separating partition 8 extends from floor 6 to a ceiling (not illustrated) common to cabin 10 and cockpit 2.

Separating partition 8 is preferably an armor-plated partition. That means that it is made of a material that can withstand projectiles from light arms (such as a pistol or revolver).

To permit access to cockpit 2, separating partition 8 is equipped with a door 12. This door 12 is a secured door. In the first place, it is also armor-plated. In addition, this door 12 is mounted in a reinforced chassis, not illustrated. Such a door mount is known to the person skilled in the art and is not described again here. This mount makes it possible to resist assaults by a person attempting to smash in the door to enter cockpit 2 by force. Door 12 permits direct access from cockpit 2 to the zone reserved for the passengers. It constitutes the only door separating cockpit 2 from cabin 10.

In cockpit 2 of FIG. 1, there are schematically illustrated a pilot station 14, a rest zone 16, a lavatory 18 and a locker 20.

Although the term pilot station 14 is sometimes synonymous with cockpit, there is understood by pilot station here the aircraft zone in which there are situated the different flight controls that permit the pilot and copilot to fly the aircraft. This zone contains in particular seats 22 for the pilot and copilot as well as the on-board instruments and control means for acting on the various elements of the aircraft, etc.

FIG. 1 illustrates an approximate positioning of pilot station 14, rest zone 16, lavatory 18 and locker 20. Pilot station 14 is preferably positioned at the front end of the aircraft, while lavatory 18, rest zone 16 and locker 20 are positioned more toward the rear of cockpit 2, or in other words close to separating partition 8. The embodiment illustrated in FIG. 1 is one example among others: it can be very easy to envision having lavatory 18 on the right in the figure, having locker 20 between rest zone 16 and separating partition 8, etc. Advantageously, in the illustrated configuration, it is noted that a pilot or a member of the flight personnel has to pass through only door 12 in order to move from cabin 10 to pilot station 14.

FIG. 2 illustrates a configuration similar to that already existing in certain long-distance aircraft as regards the relative position of the pilot station, lavatory and rest zone. The main difference is the position of separating partition 8 and secured door 12. Thus it can be noted that it is easy to change from a prior art configuration to a configuration according to the invention.

It can be provided for the invention that pilot station 14 does not necessitate any modification or adaptation compared with a prior art pilot station. This makes it possible to facilitate adaptation of the invention to an already existing aircraft.

It is already known that means for controlling the opening of a secured door can be provided at a pilot station. In the illustrated embodiment, it is possible to provide, for example, that a control system for the locking system of secured door 12 is accessible to the pilot and/or copilot. As an example, this system is then provided with:
an informing means for a request to enter, for example in the form of a bell and/or indicator light,
an informing means for knowing who is requesting to enter the cockpit: this may be a simple peephole. Nevertheless, since door 12 is not close to seats 22 of the pilot and copilot in the illustrated embodiment, it is preferable to have video means by which the pilot and/or copilot can see who is standing behind secured door 12.
a means of agreeing/refusing to open door 12.

Since the present invention is aimed at limiting direct contacts between the pilot and copilot on the one hand and the rest of the aircraft on the other hand, it is preferable to improve the means of communication between the pilots and the commercial flight personnel and possibly also the passengers. At present, there are generally provided on board an aircraft on the one hand an on-board telephone and on the other hand means whereby announcements via speakers situated in the cabin can be made from a microphone situated in the pilot station. In addition to these communication means, it can be provided, in a preferred embodiment of the invention, that a video camera with which the pilots can be seen and heard is installed in a cabin zone dedicated to this purpose. In this way, it is possible to have a good level of communication between the pilots and the rest of the aircraft while limiting the openings of secured door 12 during a flight and thus limiting the risks of intrusion into cockpit 2, which constitutes a secured zone on board the aircraft.

Lavatory 18 is preferably situated at the rear of cockpit 2, against separating partition 8. Whether it is disposed on the right or left of door 12 is immaterial. It also is noted in the drawings that door 12 is not necessarily centered relative to the longitudinal axis of the aircraft and/or separating partition 8. This lavatory 18 is separated from the rest of the cockpit by suitable partitions, and it can be accessed via a door. This door makes it possible to access lavatory 18 directly from pilot station 14 (and vice versa) without having to pass through any other door. Particular attention is preferably paid to sound insulation and ventilation of lavatory 18.

Attention should be paid to the direction of opening of the lavatory doors and of door 12 if they are disposed next to one another. In a preferred embodiment corresponding to the configuration of FIG. 2, the door of lavatory 18 opens outward. Then to avoid a conflict between the doors, secured door 12 opens toward the outside of the secured zone, or in other words toward cabin 10. Such outward opening of secured door 12 is preferred, because it makes it easier to exit cockpit 2. It also permits a construction that is more resistant to possible assaults of a person wishing to break down the door in order to enter cockpit 2. Nevertheless, it is then preferable to make adaptations to the door in order to permit the passage of air from cabin 10 to cockpit 2 in case of depressurization of cockpit 2. As an example, it is possible to provide the door with fast-acting decompression trapdoors that drop automatically in the event of depressurization.

The fact of having a private lavatory 18 in cockpit 2 limits the number of times that the pilots exit the cockpit, but also makes it possible to solve the problem, which occurs in prior art aircraft, that a lavatory may be occupied. In general, the pilots effectively share a lavatory with the passengers of the cabin. To ensure that a pilot is not absent from the cockpit for too long, it is known to reserve a lavatory by displaying an “occupied” state of this lavatory in the cabin. This lavatory may then be occupied by a pilot. The presence of a private lavatory 18 therefore also makes it possible to solve this problem of sharing of a lavatory between the passengers and the pilots.

It is already known that a rest zone intended for the pilots can be provided in an aircraft. The present invention proposes to incorporate the functionalities offered by the prior art rest zones. Nevertheless, rest zone 16 of a cockpit 2 according to the invention is accessible only from the secured zone, or in other words from the interior of cockpit 2.

As an example, rest zone 16 can be provided with one (or two) easy chairs, one (or two) comfortable recliners, the number of chairs and recliners being matched to the number of pilots who may need to occupy them.

Of course, rest zone 16 is also provided with a ventilation and lighting system. Entertainment elements (screens for watching films or for video games, etc.) may also be provided. This rest zone 16 is preferably well insulated acoustically from the rest of cockpit 2, on the one hand to permit the pilot occupying rest zone 16 to rest comfortably and on the other hand to ensure that light or other emanation from rest zone 16 does not distract the pilots at the controls of the aircraft.

In FIG. 2, rest zone 16 is disposed against separating partition 8. Nevertheless, other locations can also be envisioned.

As an example, the rest zone could be located under pilot station 14. Trapdoors (not illustrated) would then permit access to this zone from floor 6. Such a solution has the advantage of providing free space at the rear of cockpit 2, thus making it possible to bring separating partition 8 toward the front of the aircraft and in this way to enlarge the space intended for the passengers and the commercial facilities of the aircraft.

It is also conceivable to dispose rest zone 16 above cabin 10 intended for the passengers. As an example, this rest zone is then prolonged to the first luggage bins of the first rows of seats of cabin 10. Of course, access to this rest zone is possible only from cockpit 2. Some rungs along separating partition 8 can be provided in the cockpit to permit access to the rest zone. In this embodiment, the lower surface of the rest zone separating this zone from the cabin is preferably also armor-plated, to secure the rest zone.

To ensure that the secured zone is also autonomous with respect to meals and beverages for the pilots, it is preferably provided with a pantry unit, more commonly known by the English term “galley”. As an example, such a pantry unit contains hot and cold beverages, meals and also means for reheating the latter.

As an example, such a pantry unit can be located in rest zone 16, especially when this is disposed behind pilot station 14 as illustrated in FIG. 2 or else at another place at the rear of cockpit 2.

To ensure the comfort of the pilots, it is appropriate to provide good ventilation in order that the food odors to not annoy the pilots located in pilot station 14. Around the pantry unit, the floor covering will preferably be adapted such that it can be easily cleaned. Depending on the orientation of the pantry unit in cockpit 2, a facility such as a rolling shutter or a door can also be provided to prevent any splashing of liquid and/or food during turbulence, or even in the event of a crash.

Locker 20 is a storage space provided so that all the personal gear of the occupants of cockpit 2 can be stored. As an example, it is provided with a part forming a wardrobe to accommodate the jackets and garments of the occupants of cockpit 2. This wardrobe may be of reduced size, because provisions for storing overcoats and other long garments may be made outside the secured zone, such as in a wardrobe operated by code or locked by key. Locker 20 is preferably also provided with storage for the working material carried by the pilots (supplementary set of maps, specific documentation, portable computer, etc.) and the personal gear of the pilots (pilots' suitcases, hand luggage, etc.).

Locker 20 is preferably large enough to accommodate the belongings of all the pilots who are to participate in a flight, and not merely the belongings of the two pilots occupying pilot station 14.

Compared with prior art cockpits, the cockpit described in the foregoing makes it possible to offer its occupants great autonomy during a flight, even of long distance. Of course, the pilots can fly the aircraft from the pilot station, but they can also eat, drink, rest, amuse themselves and visit the lavatory made available to them.

By virtue of means of communication provided with in particular the commercial flight personnel stationed on board the aircraft, the occupants of the cockpit are not isolated and cut off from the rest of the aircraft.

It is noted that the configuration proposed by the invention, compared with an already existing configuration having a lavatory, a locker and a rest zone disposed in an airlock between the cockpit and the cabin, makes it possible to optimize the space of the aircraft dedicated to the pilots. Thus, for example, in a prior art aircraft, the cockpit (pilot station) has two or even three supplementary seats in addition to the seats intended for the pilot and copilot for flying the aircraft. The rest zone in turn has one or two seats and one or two berths. By grouping the pilot station and the rest zone in the same compartment in this way, at least one seat can be eliminated, thus making it possible to gain area on the floor.

The present invention is not limited to the preferred embodiment described in the foregoing and to the cited alternative embodiments. It also relates to all the alternative embodiments within the capacity of the person skilled in the art within the scope of the claims hereinafter.

1. A secured cockpit (2) for an aircraft intended for transportation of passengers, having on the one hand a pilot station (14) equipped with aircraft flight control means and on the other hand a wall (8) separating the said cockpit (2) from a zone (10) accessible to the passengers, the said wall (8) being equipped with a secured door (12), characterized in that it is additionally provided with a private lavatory (18) and a rest zone (16).

2. A cockpit (2) according to claim 1, characterized in that it is provided in addition with a storage space (20), such as a locker.

3. A cockpit (2) according to claim 1, characterized in that it is provided in addition with a pantry unit.

4. A cockpit (2) according to claim 1, characterized in that the private lavatory (18) and the rest zone (16) are each equipped with a partition separating them from the rest of the pilot station as well as with their own access door.

5. A cockpit (2) according to claim 1, characterized in that it is provided with communication means, with which, from a dedicated zone in the cabin, the flight personnel and/or the passengers can see and hear the pilots occupying the pilot station (14).

6. A cockpit (2) according to claim 1, characterized in that the private lavatory (18) is placed against the separating wall (8).

7. A cockpit (2) according to claim 1, characterized in that the rest zone (16) is placed at a lower level than the pilot station (14) and is accessible exclusively from the cockpit (2) via a trapdoor.

8. A cockpit (2) according to claim 1, characterized in that the rest zone (16) is placed at least partly above a zone (10) accessible to the passengers.

9. A cockpit (2) according to claim 8, characterized in that the wall separating the rest zone from the zone accessible to the passengers is armor-plated.

10. An aircraft, characterized in that it is provided with a cockpit (2) according to one of claims 1 to 9.
